(19) United States
(12) Patent Application Publication
(10) Pub. No.: US 2004/0233415 A1
(43) Pub. Date: Nov. 25, 2004

(54) Surveying instrument, target for surveying and surveying system

(75) Inventors: Masahiro Nakamura, Yokohama-shi (JP); Koki Tsujimoto, Kamakura-shi (JP)

Correspondence Address: OLIFF & BERRIDGE, PLC, P.O. BOX 19928, ALEXANDRIA, VA, 22320, US

(73) Assignees: NIKON-TRIMBLE CO., LTD., Ota-ku (JP); NIKON CORPORATION, Tokyo (JP)

(21) Appl. No.: 10/745,559

(22) Filed: Dec. 29, 2003

(30) Foreign Application Priority Data
Jan. 7, 2003 (JP) 2003-001268

(51) Int. Cl. G01C 3/08

(52) U.S. Cl. 356/4.01

(57) ABSTRACT

A target for surveying includes: a reference point and at least one first light emitting body disposed on a vertical line passing through the reference point; and at least one second light emitting body disposed on a horizontal line passing through the reference point and achieving light emitting characteristics different from the light emitting characteristics of the first light emitting body. A surveying instrument includes: a first reception device that receives signal light originating from the first light emitting body provided at a target for surveying according to claim 1 through a surveying objective lens; a second reception device that receives signal light originating from the second light emitting body provided at the target for surveying through the surveying objective lens; and an aiming control device that generates a first adjustment signal to be used to achieve aiming along a horizontal direction with the surveying objective lens based upon the signal received at the first reception device and generates a second adjustment signal to be used to achieve aiming along a vertical direction with the surveying objective lens based upon the signal received at the second reception device.

### INCORPORATION BY REFERENCE

The disclosure of the following priority application is herein incorporated by reference:

Japanese Patent Application No. 2003-1268 filed Jan. 7, 2003

### BACKGROUND OF THE INVENTION

1. Field of the Invention

The present invention relates to a surveying instrument that executes a distance measuring operation and an angle measuring operation by positioning a surveying optical system toward a survey target object, a target for surveying and a surveying system.

2. Description of the Related Art There are surveying systems known in the related art in which a surveying optical system of a surveying instrument is automatically aimed at a target by rotationally driving the surveying optical system both along the vertical direction and along the horizontal direction (see, for instance, Japanese Laid Open Patent Publication No. H 8-304545). The surveying system disclosed in Japanese Laid Open Patent Publication No. H 8-304545 includes a reflecting prism and a light source provided on the target, with the reflecting prism and the light source achieving a specific positional relationship. In addition, it includes an electro-optical distance meter and an automatic aiming mechanism achieving a specific positional relationship to the electro-optical distance meter, both provided on the surveying instrument. As light is emitted from the light source at the target toward the surveying instrument, the automatic aiming mechanism fine-adjusts the orientation of the surveying instrument (the orientation of the electro-optical distance meter and the orientation of the automatic aiming mechanism itself) both along the vertical direction and along the horizontal direction so that the light is received at the center of a quarter-split light-receiving element at a first light-receiving unit within the automatic aiming mechanism of the surveying instrument.

A surveying system normally executes a measurement in both face-positions of the telescope to improve the accuracy of angle measurement by canceling the mechanical error of the surveying instrument. In the measuring operation in both face-positions of the telescope, after executing an initial angle measurement, a second angle measurement is executed by reversing the orientation of the surveying instrument by 180°. The measuring operation in both face-positions of the telescope is executed to measure the angle along the vertical direction and the horizontal direction. When the surveying instrument is rotated by 180° along the vertical direction in the surveying system disclosed in Japanese Laid Open Patent Publication No. H8-304545, the top/bottom positional relationship between the surveying optical system (electro-optical distance meter) and the automatic aiming mechanism (in particular the first light-receiving unit) becomes reversed and no longer matches the positional relationship achieved between the reflecting prism and the light source on the target. For this reason, the angle measurement accuracy cannot be improved simply by executing the measuring operation in both face-positions of the telescope along the vertical direction and a further correction must be executed.

### SUMMARY OF THE INVENTION

The present invention provides a compact automatic aiming surveying instrument, a target for surveying and an automatic aiming surveying system.

A target for surveying according to the present invention comprises: a reference point and at least one first light emitting body disposed on a vertical line passing through the reference point; and at least one second light emitting body disposed on a horizontal line passing through the reference point and achieving light emitting characteristics different from the light emitting characteristics of the first light emitting body.

In this target, it is preferred that the light emitting characteristics of the first light emitting body and the light emitting characteristics of the second light emitting body differ from each other at least either in an emission wavelength or in a modulation frequency.

It is also preferred that: the first light emitting body is provided as a pair of light emitting bodies disposed above and below the reference point on the vertical line; and the second light emitting body is provided as a pair of light emitting bodies disposed left and right relative to the reference point on the horizontal line.

A surveying instrument according to the present invention comprises: a first reception device that receives signal light originating from the first light emitting body provided at a target for surveying according to claim 1 through a surveying objective lens; a second reception device that receives signal light originating from the second light emitting body provided at the target for surveying through the surveying objective lens; and an aiming control device that generates a first adjustment signal to be used to achieve aiming along a horizontal direction with the surveying objective lens based upon the signal received at the first reception device and generates a second adjustment signal to be used to achieve aiming along a vertical direction with the surveying objective lens based upon the signal received at the second reception device.

In this surveying instrument, it is preferred that: the first reception device comprises at least a first light wavelength discriminating device that discriminates for light corresponding to a wavelength component of the light emitted by the first light emitting body and a first light-receiving device that comprises two light-receiving elements disposed side-by-side along the horizontal direction and receives the light selected by the first light wavelength discriminating device at the two light-receiving elements to execute photoelectric conversion; and the second reception device comprises at least a second light wavelength discriminating device that discriminates for the light corresponding to a wavelength component of the light emitted by the second light emitting body and a second light-receiving device that comprises two light-receiving elements disposed side-by-side along the vertical direction and receives the light selected by the second light wavelength discriminating device at the two light-receiving elements to execute photoelectric conversion. In this case, it is preferred that the aiming control device generates the first adjustment signal so as to set a difference between photoelectric conversion signals from the two light-receiving elements of the first light-receiving device to substantially 0 and generates the second adjustment signal so as to set a difference between photoelectric conversion signals from the two light-receiving elements of the second light-receiving device to substantially 0. It is also preferred that: the first reception device further comprises a first frequency discriminating device that discriminates for a modulation frequency component of the signal light from the first light emitting body in photoelectric conversion signals obtained at the first light-receiving device; and the second reception device further comprises a second frequency discriminating device that discriminates for a modulation frequency component of the signal light from the second light emitting body in photoelectric conversion signals obtained at the second light-receiving device.

Another surveying instrument according to the present invention comprises: a light wavelength discriminating device that discriminates for both light originating from the first light emitting body and light originating from the second light emitting body provided at a target for surveying according to claim 1, which enter therein through a surveying objective lens; a light-receiving device having four light-receiving elements disposed side-by-side along a horizontal direction and along a vertical direction, which receives light discriminated for at the light wavelength discriminating device at the four light-receiving elements and performs photoelectric conversion of the received light; a first signal processing device that individually extracts photoelectric conversion signals provided by the two light-receiving elements located on the left side along the horizontal direction at the light-receiving device and photoelectric conversion signals provided by the two light-receiving elements located on the right side along the horizontal direction at the light-receiving device; a first frequency discriminating device that discriminates for a modulation frequency component of the signal light from the first light emitting body in the photoelectric conversion signals extracted by the first signal processing device; a second signal processing device that individually extracts the photoelectric conversion signals provided by the two light-receiving elements located on the upper side along the vertical direction at the light-receiving device and the photoelectric conversion signals provided by the two light-receiving elements located on the lower side along the vertical direction at the light-receiving device; a second frequency discriminating device that discriminates for a modulation frequency component of the signal light from the second light emitting body in the photoelectric conversion signals extracted by the second signal processing device; and an aiming control device that generates a first adjustment signal to be used to achieve aiming along the horizontal direction with the surveying objective lens based upon a discriminate signal provided by the first frequency discriminating device and generate a second adjustment signal to be used to achieve aiming along the vertical direction with the surveying objective lens based upon a discriminate signal provided by the second frequency discriminating device.

In this surveying instrument, it is preferred that the aiming control device generates the first adjustment signal so as to set a difference between the two photoelectric conversion signals having undergone a discriminating process executed by the first frequency discriminating device to substantially 0 and generates the second adjustment signal so as to set a difference between the two photoelectric conversion signals having undergone a discriminating process executed by the second frequency discriminating device to substantially 0.

In the above surveying instruments, it is preferred that a surveying optical system and an aiming optical system share a single optical axis and the surveying optical system and the aiming optical system both include and share the surveying objective lens.

Still another surveying instrument according to the present invention comprises: a surveying device that measures at least either a distance to or an angle of a target for surveying through a surveying objective lens; a reception device that receives signal light originating from a light emitting body provided at the target for surveying through the surveying objective lens and outputs a reception signal; and an aiming control device that aims an optical axis of the surveying objective lens at the target for surveying based upon the reception signal obtained at the reception device.

In this surveying instrument, it is preferred that: the reception device outputs a horizontal differential signal indicating an extent to which the optical axis of the surveying objective lens is offset relative to the target for surveying along a horizontal direction and a vertical differential signal indicating an extent to which the optical axis of the surveying objective lens is offset relative to the target for surveying along a vertical direction; and the aiming control device aims the optical axis of the surveying objective lens at the target for surveying both along the horizontal direction and along the vertical direction based upon the horizontal differential signal and the vertical differential signal. In this case, it is preferred that: the target for surveying comprises at least one first light emitting body positioned along the horizontal direction relative to the center of the target and at least one second light emitting body positioned along the vertical direction relative to the center of the target; and the reception device outputs the vertical differential signal based upon signal light originating from the first light emitting body and outputs the horizontal differential signal based upon signal light originating from the second light emitting body.

It is also preferred that the surveying device executes measurement in both face-positions of a telescope.

An automatic aiming surveying system according to the present invention comprises: a target for surveying according to claim 1; and a surveying instrument, and: the surveying instrument comprises; a first reception device that receives signal light originating from the first light emitting body provided at the target for surveying through a surveying objective lens; a second reception device that receives signal light originating from the second light emitting body provided at the target for surveying through the surveying objective lens; and an aiming control device that generates a first adjustment signal to be used to achieve aiming along a horizontal direction with the surveying objective lens based upon a reception signal obtained at the first reception device and generates a second adjustment signal to be used to achieve aiming along a vertical direction with the surveying objective lens based upon a reception signal obtained at the second reception device.

Another automatic aiming surveying system according to the present invention comprises: a target for surveying; and a surveying instrument, and: the surveying instrument comprises; a surveying device that measures at least either a distance to or an angle of the target for surveying through a surveying objective lens; a reception device that receives signal light originating from a light emitting body provided at the target for surveying through the surveying objective lens and outputs a reception signal; and an aiming control device that aims an optical axis of the surveying objective lens at the target for surveying based upon the reception signal obtained at the reception device.

### BRIEF DESCRIPTION OF THE DRAWINGS

FIG. 1 is a plan view of an automatic aiming surveying system in which a surveying instrument achieved in a first embodiment of the present invention is aimed at a target;

FIG. 2 is a side elevation of the automatic aiming surveying system in FIG. 1;

FIG. 3 is an optical block diagram of a surveying optical system built within a telescope unit;

FIG. 4 illustrates the target according to the present invention;

FIG. 5 shows a structure of the target and structural features of the telescope unit used in automatic aiming;

FIG. 6 is a block diagram of structural features of the surveying instrument used in automatic aiming control;

FIG. 7 presents a flowchart of the automatic aiming processing executed by a microcomputer in the surveying instrument;

FIG. 8 shows structural features of a telescope unit used in automatic aiming in a second embodiment;

FIG. 9 is a block diagram of a surveying instrument; and

FIG. 10 presents a flowchart of the automatic aiming processing executed by a microcomputer in the surveying instrument.

### DESCRIPTION OF THE PREFERRED EMBODIMENTS

The following is an explanation of the embodiments of the present invention, given in reference to the drawings.

### First Embodiment

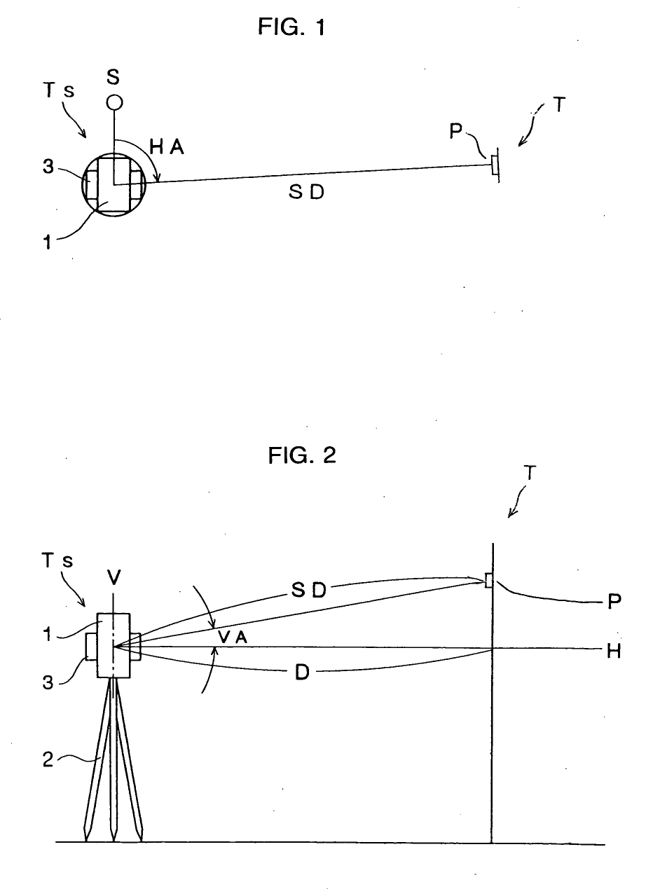

FIG. 1 is a plan view of an automatic aiming surveying system that utilizes a surveying instrument Ts achieved in the first embodiment of the present invention to be aimed at or be collimated toward a target T and FIG. 2 is a side elevation of FIG. 1. The term “aim or collimate” in this context refers to an instance of setting the optical axis of the telescope of the surveying instrument accurately toward the target. The surveying instrument Ts in FIGS. 1 and 2 is a so-called total station distance measuring/angle measuring apparatus capable of executing measurement in both face-positions of the telescope. A main body 1 of the surveying instrument Ts includes a rotary support unit (not shown) fixed on a tripod 2 or the like and is allowed to rotate freely along the horizontal direction. The main body 1 is rotatably supported by the rotary support unit so that the main body 1 is allowed to rotate within a horizontal plane parallel to a horizontal line H on the tripod 2. A telescope unit 3 having a surveying optical system is provided at the main body 1. The main body 1 includes a horizontal shaft (not shown) which is allowed to rotate freely along the vertical direction, and the telescope unit 3 is supported by the horizontal shaft so that the telescope unit 3 is allowed to rotate within a vertical plane that contains a vertical line V. In other words, the telescope unit 3 is allowed to rotate freely both along the horizontal direction and along the vertical direction.

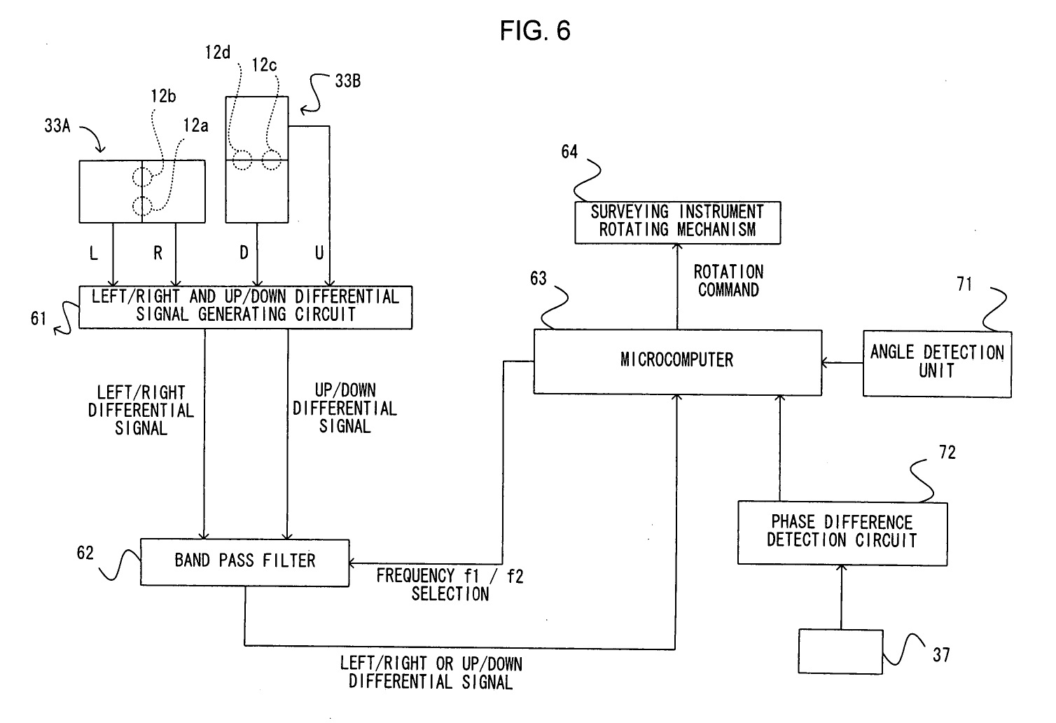

As the telescope unit 3 is oriented toward a reflecting prism P provided at the center of the target T, i.e., as the telescope unit 3 is aimed at the center of the target T, the surveying instrument Ts detects a horizontal angle HA formed as the rotational angle of the rotary support unit with a horizontal angle detection unit (not shown, included in an angle detection units 71 in FIG. 6) and detects an elevation (or vertical) angle VA formed as the rotational angle of the horizontal shaft with an elevation angle detection unit (not shown, included in the angle detection unit 71 in FIG. 6). The horizontal angle HA is an angle formed within the horizontal plane indicating the direction of the target T relative to a survey reference point S, whereas the elevation angle VA is an angle formed within the vertical plane indicating the direction of the reflecting prism P relative to the horizontal plane.

The telescope unit 3 is capable of emitting modulated light to be used in distance measurement. The modulated light is achieved by altering the level of the drive current used to drive the light source at a predetermined frequency so that the intensity of the light emitted from the light source changes cyclically. The modulated light emitted from the telescope unit 3 toward the reflecting prism P is reflected at the reflecting prism P and advances toward the telescope unit 3. The surveying instrument Ts guides the reflected light entering the telescope unit 3 to a distance measuring device (not shown). The distance measuring device determines a slanted distance SD from the surveying instrument Ts to the reflecting prism P by detecting the difference between the modulation signal phase of the emitted light and the modulation signal phase of the light entering the telescope unit 3. Under normal circumstances, the surveying instrument Ts either receives modulated light reflected by a reflecting prism (corner cube) at a target set at the measuring point or receives scattered light originating from the measurement target. In this example, the target T having the reflecting prism P is used in the measuring operation.

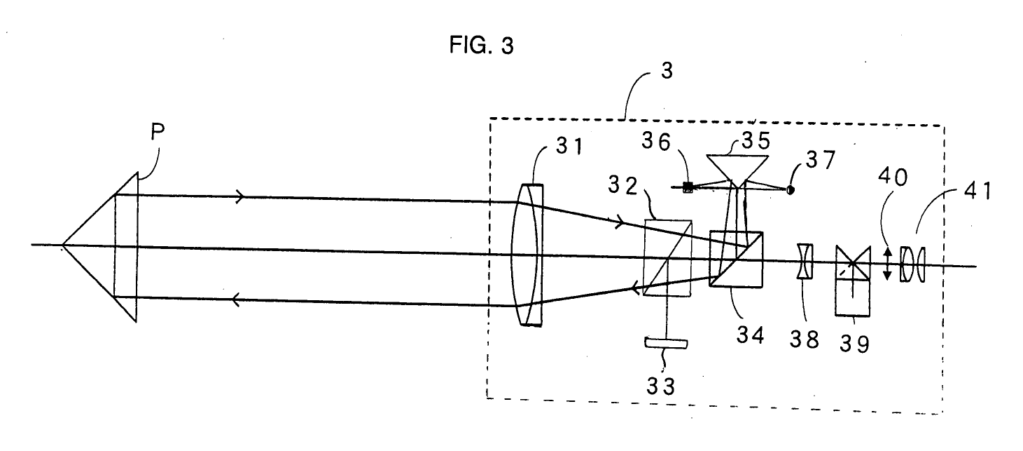

FIG. 3 is an optical block diagram of the surveying optical system built in to the telescope unit 3. The surveying optical system includes a distance measuring optical system and an aiming optical system. In FIG. 3, the distance measuring optical system includes an objective lens 31, a dichroic prism 34 and a split prism 35. The distance measuring optical system projects modulated light generated at a near-infrared light source 36 toward the reflecting prism P at the target T (see FIGS. 1 and 2) via the objective lens 31 and also guides light reflected by the reflecting prism P and entering from the objective lens 31 toward a light-receiving element 37.

The aiming optical system includes the objective lens 31, dichroic prisms 32 and 34, a focusing lens 38, an erect prism 39, a reticle 40 and an eye-piece lens 41. The aiming optical system forms an image constituted of the visible wavelength component in subject light entering from the objective lens 31 on the reticle 40 and also guides the modulated light originating at the near-infrared light source which is sent from the target T (see FIGS. 1 and 2) and enters through the objective lens 31 toward a light-receiving element 33. The objective lens 31 and the dichroic prism 34 are both shared by the distance measuring optical system and the aiming optical system, which also share a single optical axis. It is to be noted that the target T, which includes the light source, is to be described in detail later.

A standard measuring operation may be executed by the surveying instrument Ts through, for instance, the following procedure.

1. Place an anchor point 11 located at the front end of the pole of the target T at the measuring point and set the target T upright.

2. Aim the telescope unit 3 at the target T.

3. Measure the horizontal angle HA and the elevation angle VA.

4. Emit modulated light from the near-infrared light source 36 (a laser or an LED that emits infrared light) and execute a distance measurement with the distance measuring optical system by receiving part of the transmission light and the reception light reflected by the reflecting prism P at the light-receiving element 37.

Since the present invention is characterized in the operation in 2 above, during which “the telescope unit 3 is aimed at the target T”, the following explanation focuses on the aiming operation. The surveying instrument Ts is configured to enable the surveying instrument Ts to automatically adjust the orientation of the telescope unit 3 to achieve an accurate aiming at the target T as well as allowing the operator (observer) to observe the target T by using the aiming optical system.

Observation by the Operator Enabled by Using the Aiming Optical System

The reflected light from the target T, manifesting as illuminating light (natural light or the like) illuminating the target T is reflected at the target T enters the dichroic prism 32 via the objective lens 31 in FIG. 3. The visible wavelength component in the light having entered the dichroic prism 32 passes through the dichroic prism 32, the dichroic prism 34, the focusing lens 38 and the erect prism 39 and forms an image of the target T on the reticle 40. The erect image thus formed is observed by the operator through the eye-piece lens 41. The operator focuses the image of the target T onto the reticle 40 by driving the focusing lens 38 so as to move it forward/backward, i.e., to the left/right in FIG. 3, along the optical axis.

Automatic Aiming

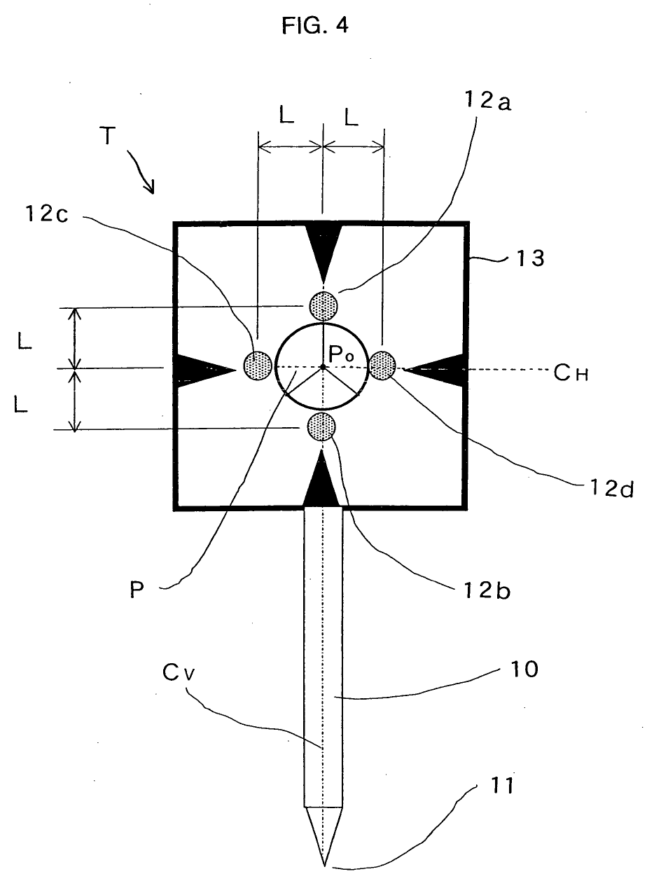

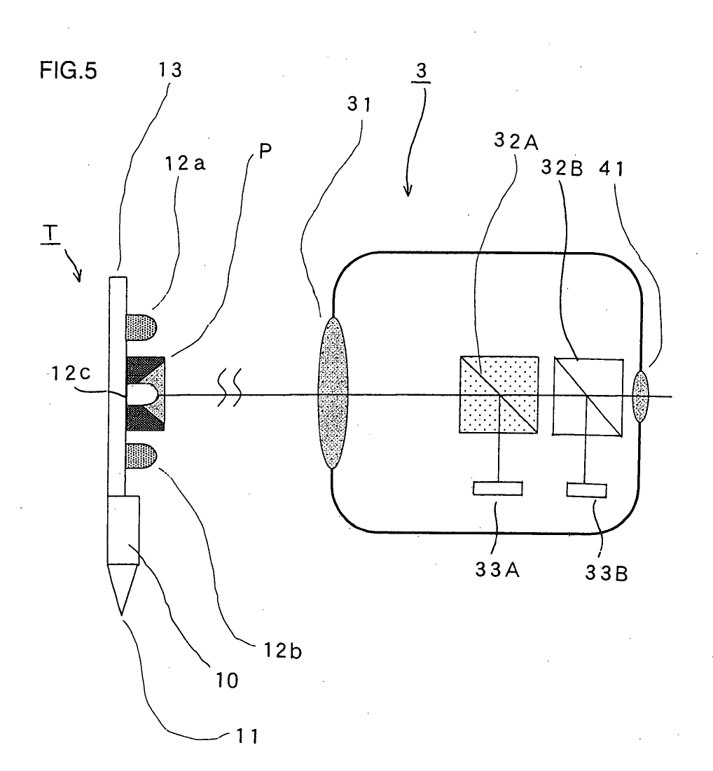

FIG. 4 illustrates the target T achieved in the present invention. The target T in FIG. 4 comprises a pole 10 and a target portion 13. The target T is used by placing the anchor point 11 located at the front end of the pole 10 at the measuring point and setting the target upright. At the target portion 13, the reflecting prism P and four LED light sources 12a to 12d are provided. The reflecting prism P is disposed on a vertical center line CV. The LED light source 12a is disposed on the vertical center line CV at an upper position relative to the center Po of the reflecting prism P over a distance L from the center Po, and the LED light source 12b is disposed on the vertical center line CV at a lower position relative to the center Po of the reflecting prism P over the distance L from the center Po. In addition, the LED light source 12c is disposed on a horizontal line CH passing through the center Po of the reflecting prism P at a position set to the left of the center Po of the reflecting prism P over the distance L, whereas the LED light source 12d is disposed on the horizontal line CH at a position set to the right of the center Po of the reflecting prism P over the distance L.

The LED light source 12a and the LED light source 12b are driven so that they both emit light with a modulation frequency f1 and an emission wavelength λ1 achieving light outputs substantially equal to each other. The LED light source 12c and the LED light source 12d are driven so that they both emit light with a modulation frequency f2 and an emission wavelength λ2 achieving light outputs substantially equal to each other. The levels of the drive currents used to drive the LED light source 12a and the LED light source 12b are altered respectively at the frequencies f1 and f2 so as to cyclically change the levels of intensity with which the modulated light is emitted from the LED light source 12a and the modulated light is emitted from the LED light source 12b. In the first embodiments, the modulation frequencies f1 and f2 differ from each other and the emission wavelengths λ1 and λ2 differ from each other. It is to be noted that the wavelengths λ1 and λ2 are both within a wavelength range of 650 nm through 1300 nm, i.e., within the visible to infrared wavelength range, and it should be ensured that they both greatly different from the wavelength of the light emitted from the near-infrared light source 36 utilized for distance measurement. In addition, it is desirable to set the frequencies f1 and f2 each to a value such as 6 KHz or 7 KHz, i.e., a value greatly differing from the modulation frequency of the distance measuring light source. The angle to which the light emitted from each of the LED light sources 12a to 12d diverges is set to, for instance, ±10°.

FIG. 5 shows the structure of the target T and the structural features of the telescope unit 3 used in automatic aiming. It is to be noted that while the eye-piece lens 41 described earlier is included in the illustration, it is not directly required for the automatic aiming. A dichroic prism 32A and a dichroic prism 32B in FIG. 5 correspond to the dichroic prism 32 in FIG. 3. In addition, a half-split light-receiving sensor 33A and a half-split light-receiving sensor 33B are equivalent to the light-receiving element 33 in FIG. 3. The half-split light-receiving sensor 33A includes two photodiodes (PDs) disposed side-by-side along the left/right (horizontal) direction, and the two light-receiving sensors individually output light reception signals (an L signal and an R signal). The half-split light-receiving sensor 33B includes two light-receiving sensors disposed side-by-side along the up/down (vertical) direction, and the two light-receiving sensors individually output light reception signals (a U signal and a D signal). It is to be noted that the light reception signals (photoelectric conversion signals) are each output as a current signal indicating a value that changes in correspondence to the quantity of light entering the light-receiving surface of the photodiode.

The modulated light transmitted from the LED light sources 12a to 12d enters the dichroic prism 32A via the objective lens 31. The dichroic prism 32A redirects the wavelength component with the wavelength λ1 in the incident light and guides the redirected light to the half-split light-receiving sensor 33A and allows a wavelength component corresponding to the light with the wavelength λ2 and the visible light to be transmitted to be guided to the dichroic prism 32B. As a result, the light from the LED light source 12a and the light from the LED light source 12b disposed above and below the reflecting prism P are received at the half-split light-receiving sensor 33A. It is to be noted that the dichroic prism 32A also allows the light with the wavelength component attributable to the near-infrared light source 36 to be transmitted during the distance measuring operation.

The dichroic prism 32B redirects the wavelength component with the wavelength λ2 in the incident wavelength guides the redirected wavelength component to the half-split light-receiving sensor 33B and allows a wavelength component including the visible light wavelength to be transmitted to be guided toward the eye-piece lens 41. Thus, the light from the LED light source 12c and the light from the LED light source 12d disposed to the left and the right relative to the reflecting prism P are received at the half-split light-receiving sensor 33B. It is to be noted that the dichroic prism 32B also allows the light with the wavelength component attributable to the near-infrared light source 36 to be transmitted during the distance measuring operation.

FIG. 6 is a block diagram showing the components of the surveying instrument Ts used in automatic aiming control. The surveying instrument Ts in FIG. 6 includes a left/right and up/down differential signal generating circuit 61, a band pass filter 62, a microcomputer 63 and a surveying instrument rotating mechanism 64. The light reception signals provided by the half-split light-receiving sensor 33A and the light reception signals provided by the half-split light-receiving sensor 33B are all input to the left/right and up/down differential signal generating circuit 61.

The left/right and up/down differential signal generating circuit 61 generates a differential signal (L-R) indicating the difference between the L signal and the R signal input from the half-split light-receiving sensor 33A and outputs the left/right differential signal thus generated to the band pass filter 62. When the optical axis of the telescope unit 3 is aligned with the direction of the center (the center Po of the reflecting prism P in this example) of the target T within the horizontal plane, the L signal and the R signal indicate values equal to each other and thus, the differential signal (L-R) indicates a value of 0. When the optical axis of the telescope unit 3 is set further leftward (further toward the LED light source 12c) relative to the center of the target T within the horizontal plane, the L signal indicates a value larger than the value indicated by the R signal and, accordingly, the differential signal (L-R) indicates the value larger than 0. When the optical axis of the telescope unit 3 is set further rightward (further toward the LED light source 12d) relative to the center of the target T within the horizontal plane, the value indicated by the L signal is smaller than the value of the R signal and, as a result, the differential signal (L-R) indicates a value smaller than 0.

In addition, the left/right and up/down differential signal generating circuit 61 generates a differential signal (U-D) indicating the difference between the U signal and the D signal input from the half-split light-receiving sensor 33B and outputs the up/down differential signal thus generated to the band pass filter 62. When the optical axis of the telescope unit 3 is aligned with the direction of the center of the target T within the vertical plane, the U signal and the D signal indicate values equal to each other and thus, the differential signal (U-D) indicates a value of 0. When the optical axis of the telescope unit 3 is set further upward (further toward the LED light source 12a) relative to the center of the target T within the vertical plane, the U signal indicates a value larger than the value indicated by the D signal and, accordingly, the differential signal (U-D) indicates a value larger than 0. When the optical axis of the telescope unit 3 is set further downward (further toward the LED light source 12b) relative to the center of the target T within the vertical plane, the value indicated by the U signal is smaller than the value of the D signal and, as a result, the differential signal (U-D) indicates a value smaller than 0.

The band pass filter 62 selects a signal with the frequency f1 or a signal with the frequency f2 and outputs the selected signal to the microcomputer 63 in response to a command issued by the microcomputer 63. If the band pass filter 62 selects the signal with the frequency f1, the left/right differential signal is input to the microcomputer 63, whereas if the band pass filter 62 selects the signal with a frequency f2, the up/down differential signal is input to the microcomputer 63.

Based upon the left/right differential signal input to the microcomputer 63 in response to a command issued for the band pass filter 62 to select the signal with the frequency fi, the microcomputer 63 outputs a horizontal rotation command to the surveying instrument rotating mechanism 64 so as to set the value of the differential signal to 0. In response, the surveying instrument rotating mechanism 64 rotates the telescope unit 3 within the horizontal plane by driving a motor (not shown). In addition, based upon the up/down differential signal input to the microcomputer 63 in response to a command issued for the band pass filter 62 to select the signal with the frequency f2, the microcomputer 63 outputs a vertical rotation command to the surveying instrument rotating mechanism 64 so as to set the value of the differential signal to 0. In response, the surveying instrument rotating mechanism 64 rotates the telescope unit 3 within the vertical plane by driving a motor (not shown).

The optical axis of the telescope unit 3 is aligned with the target center Po when both the left/right differential signal and the up/down differential signal indicate a value of 0. In FIG. 3, the near-infrared light source 36 and the light-receiving element 37 are each set at the focus position of the objective lens 31, and the near-infrared light source 36 and the light-receiving element 37 are disposed at positions optically conjugate with each other. For this reason, when the aiming optical system is aimed at the target center Po, the measuring light flux originating at the near-infrared light source 36 is emitted toward the reflecting prism P via the objective lens 31 as a parallel light flux, and reflected light from the reflecting prism P enters the objective lens 31 as a parallel light flux to be condensed onto the light-receiving element 37.

It is to be noted that the left/right differential signal may be regarded as a signal that indicates the extent to which the optical axis of the telescope unit 3 is offset to the left/right (along the horizontal direction) relative to the target center Po, whereas the up/down differential signal may be regarded as a signal that indicates the extent to which the optical axis of the telescope unit 3 is offset upward/downward (along the vertical direction) relative to the target center Po.

Angle Measurement

As the operator operates an angle measurement switch (not shown) of the surveying instrument Ts, the surveying instrument Ts detects the horizontal angle HA formed as the rotational angle of the rotary support unit and the elevation angle VA formed as the rotational angle of the horizontal shaft with the angle detection unit 71. The horizontal angle HA is an angle formed within the horizontal plane, which indicates the direction of the target T relative to the survey reference point S (see FIG. 1), whereas the elevation angle VA is an angle formed within the vertical plane, which indicates the direction of the reflecting prism P relative to the horizontal line H (see FIG. 2). It is to be noted that the surveying instrument Ts achieved in the embodiment executes measurement in both face-positions of the telescope during the angle measurement. In the measuring operation in both face-positions of the telescope, after an initial angle measurement is executed, the orientation of the surveying instrument is reversed by 180° by using the surveying instrument rotating mechanism 64 and then a second angle measurement is executed. The measuring operation in both face-positions of the telescope is executed to measure the angle both along the vertical direction and the horizontal direction. The angle measuring device is constituted with the angle detection unit 71, the microcomputer 63, the surveying instrument rotating mechanism 64 and the like.

Distance Measurement

As the operator turns on a switch (not shown) to turn on the near-infrared light source 36 of the surveying instrument Ts, a drive circuit (not shown) starts supplying a drive current to the near-infrared light source 36. The intensity of the drive current is modulated so as to enable the near-infrared light source 36 to generate modulated light with a predetermined frequency. The modulated light emitted from the near-infrared light source 36 is split at the split prism 35 and part of the light enters the dichroic prism 34. The other part of the modulated light resulting from the split is received at the light-receiving element 37 as measurement reference light. A detailed explanation of the measurement reference light is not provided in this document except that it is light used to execute a distance measuring operation along a predetermined optical path within the distance measuring device in order cancel out in any measurement error attributable to the electronic circuit. The dichroic prism 34 has characteristics whereby it reflects the infrared light from the near-infrared light source 36 and allows light in the visible light range to be transmitted. The measuring light (modulated light) having entered the dichroic prism 34 is redirected inside the dichroic prism 34 and is then directed toward the reflecting prism P from the dichroic prism 32 through the objective lens 31.

The reflecting prism P reflects the measuring light from the near-infrared light source 36. The reflected light from the reflecting prism P enters the dichroic prism 34 via the objective lens 31 and the dichroic prism 32. The reflected light having entered the dichroic prism 34 is redirected inside the dichroic prism 34, is further redirected at the split prism 35 and then enters the light-receiving element 37. The distance measuring device detects the difference between the phases of the measuring light and the phases of the reflected light with a phase difference detection circuit 72 (see FIG. 6) and calculates the distance to the reflecting prism P based upon the detected phase difference. Since the phase difference detection circuit is of the known art, an explanation for it is omitted. The distance measuring device is constituted with the near-infrared light source 36, the light-receiving element 37, the phase difference detection circuit 72, the microcomputer 63 and the like. It is to be noted that, in some applications (depending upon the purpose of the measuring operation), the distance measuring operation may also be achieved through measurement in both face-positions of the telescope.

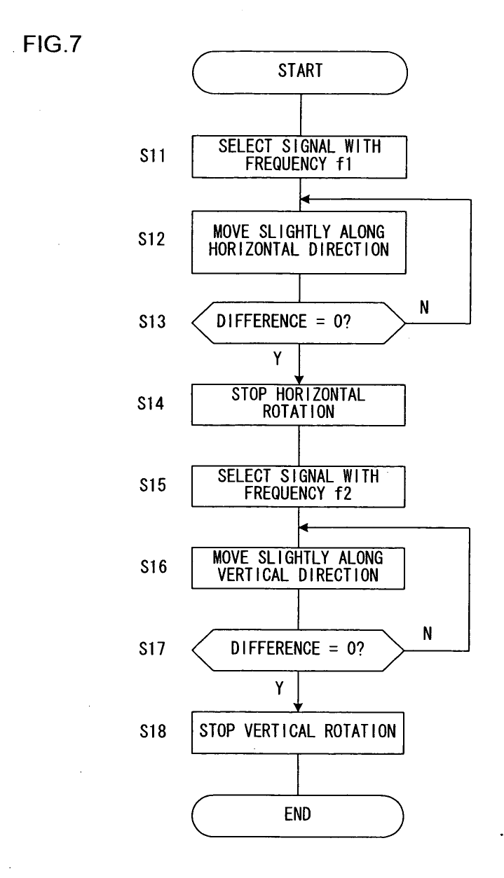

The flow of the automatic aiming processing executed by the microcomputer 63 of the surveying instrument Ts described above is now explained in reference to the flowchart presented in FIG. 7. The processing in FIG. 7 is started up as the operator operates an auto-aiming start switch (not shown) after coarsely adjusting the orientation of the telescope unit 3 so that the target T can be observed through the eye-piece lens 41. It is to be noted that the LED light sources 12a to 12d are turned on in advance. In step S11, the microcomputer 63 outputs a command for the band pass filter 62 to select the signal with the frequency f1 before the operation proceeds to step S12. In step S12, the microcomputer 63 outputs a horizontal rotation command to the surveying instrument rotating mechanism 64 based upon the left/right differential signal input from the band pass filter 62, and then the operation proceeds to step S13. As a result, the telescope unit 3 is caused to move slightly to the left/right within the horizontal plane.

In step S13, the microcomputer 63 makes a decision as to whether or not the left/right differential signal indicates a value of 0. The microcomputer 63 makes an affirmative decision in step S13 if the value indicated by the left/right differential signal is equal to or smaller than a predetermined value to proceed to step S14, whereas it makes a negative decision in step S13 if the value of the left/right differential signal is greater than the predetermined value to return to step S12. The operation returns to step S12 to allow the telescope unit 3 to keep moving slightly along the horizontal direction. In step S14, the microcomputer 63 outputs a horizontal rotation stop command to the surveying instrument rotating mechanism 64 before the operation proceeds to step S15.

In step S15, the microcomputer 63 outputs a command for the band pass filter 62 to select the signal with the frequency f2 before the operation proceeds to step S16. In step S16, the microcomputer 63 outputs a vertical rotation command to the surveying instrument rotating mechanism 64 based upon the up/down differential signal input from the band pass filter 62, and then the operation proceeds to step S17. As a result, the telescope unit 3 is caused to move slightly up/down within the vertical plane.

In step S17, the microcomputer 63 makes a decision as to whether or not the up/down differential signal indicates a value of 0. The microcomputer 63 makes an affirmative decision in step S17 if the value indicated by the up/down differential signal is equal to or smaller than a predetermined value to proceed to step S18, whereas it makes a negative decision in step S17 if the value of the up/down differential signal is greater than the predetermined value to return to step S16. The operation returns to step S16 to allow the telescope unit 3 to keep moving slightly along the vertical direction. In step S18, the microcomputer 63 outputs a vertical rotation stop command to the surveying instrument rotating mechanism 64 before the processing in FIG. 7 ends.

The following advantages are achieved in the first embodiment explained above.

(1) The LED light source 12a, which emits light with the emission wavelength λ1 is disposed at an upper position relative to the center Po of the reflecting prism P over the distance L and an LED light source 12b, which emits light with the emission wavelength λ1 is disposed at a lower position relative to the center Po over the distance L, both on the vertical center line CV of the target T. The LED light sources 12a and 12b are both made to emit modulated light with the frequency f1. The half-split light-receiving sensor 33A is provided at the telescope unit 3 of the surveying instrument Ts to receive the modulated light from the LED light source 12a and the modulated light from the LED light source 12b. The half-split light-receiving sensor 33A is constituted with two light-receiving sensors disposed side-by-side along the left/right (horizontal) direction. When the light-receiving points at which the light originating from the pair of LED light sources 12a and 12b disposed along the vertical direction are both set on the dividing line that splits the half-split light-receiving sensor 33A into the two halves, the difference between the values indicated by the L signal and the R signal is 0. Accordingly, the direction of the optical axis of the telescope unit 3 within the horizontal plane, i.e., whether or not the optical axis is set toward the target center Po, can be detected with a high degree of accuracy based upon the values of the L signal and the R signal provided by the half-split light-receiving sensor 33A. In addition, since the LED light sources 12a and 12b emit modulated light with the frequency f1, it is possible to eliminate any influence of extraneous light such as sunlight or light from an electric lamp (unmodulated light and modulated light with a frequency other than the frequency f1). Furthermore, since the LED light source 12a and the LED light source 12b are both disposed on the vertical center line CV, the telescope unit 3 can be aimed along the horizontal direction even when the quantities of light emitted from the two light sources 12a and 12b do not match. If, on the other hand, the quantities of light emitted from the two light sources are equal to each other, the telescope unit 3 can be aimed along the vertical direction as well, since the LED light sources 12a and 12b are disposed at an upper position and a lower position relative to the center Po so as to achieve symmetry relative to the center Po.

(2) The LED light source 12c, which emits light with the emission wavelength λ2 is disposed at a position to the left relative to the center Po of the reflecting prism P over the distance L and an LED light source 12d, which emits light at the emission wavelength λ2, is disposed at a position to the right relative to the center Po over the distance L, both on the horizontal line CH passing through the center Po of the reflecting prism P. The LED light sources 12c and 12d are both made to emit modulated light with the frequency f2. The half-split light-receiving sensor 33B is provided at the telescope unit 3 of the surveying instrument Ts to receive the modulated light from the LED light source 12c and the modulated light from the LED light source 12d. The half-split light-receiving sensor 33B is constituted with two light-receiving sensors disposed side-by-side along the up/down (vertical) direction. When the light-receiving points at which the light originating from the pair of LED light sources 12c and 12d disposed along the horizontal direction are both set on the dividing line that splits the half-split light-receiving sensor 33B into the two halves, the difference between the values indicated by the U signal and the D signal is 0. Accordingly, the direction of the optical axis of the telescope unit 3 within the vertical plane, i.e., whether or not the optical axis is set toward the target center Po, can be detected with a high degree of accuracy based upon the values of the U signal and the D signal provided by the half-split light-receiving sensor 33B. In addition, since the LED light sources 12c and 12d emit modulated light with the frequency f2, which is different from the frequency f1, it is possible to eliminate any influence of the signal light with the frequency f1 in (1) described above as well as the influence of extraneous light such as sunlight or light from an electric lamp. Furthermore, since the LED light source 12c and the LED light source 12d are both disposed on the horizontal line CH, the telescope unit 3 can be aimed along the vertical direction even when the quantities of light emitted from the two light sources 12c and 12d do not match.

(3) Since the emission wavelength at the LED light source 12a and the LED light source 12b is set to λ1 and the emission wavelength at the LED light source 12c and the LED light source 12d is set to λ2, the modulated light originating from the target T can be individually guided to the half-split light-receiving sensor 33A and the half-split light-receiving sensor 33B by utilizing the dichroic prism 32A that discriminates for light with the wavelength λ1 and the dichroic prism 32B which discriminates for light with the wavelength λ2 respectively.

(4) Since both the emission wavelengths λ1 and λ2 at the LED light source 12a to LED light source 12d are wavelengths in the near-infrared range, the operator is able to observe the image formed with the visible light from the reflecting prism P on the reticle 40 by the aiming optical system through the eye-piece lens 41.

(5) Since a single optical axis is set as both the optical axis of the distance measuring optical system and the optical axis of the aiming optical system so as to allow the distance measuring optical system and the aiming optical system to share a single objective lens, the positional relationship between the distance measuring optical system and the aiming optical system is not reversed during the measuring operation in both face-positions of the telescope, unlike in the related art in which the optical axes of the two optical systems are offset from each other, and thus, accuracy of the angle measurement can be improved both along the horizontal direction and along the vertical direction.

(6) In addition to the advantage described in (5) above, a more compact telescope unit 3 is achieved and also the production cost can be reduced since a single objective lens is shared by the distance measuring optical system and the aiming optical system.

While the modulation frequency f1 of the LED light source 12a and the LED light source 12b differs from the modulation frequency f2 at the LED light source 12c and the LED light source 12d in the explanation given above, a single modulation frequency (e.g. the frequency f1) may be set for all the LED light sources 12a through 12d as long as the dichroic prism 32A and the dichroic prism 32B are capable of discriminating for light with the wavelength λ1 and the light with the wavelength λ2 from each other effectively. In such a case, instead of the band pass filter 62, which selects a passing frequency, a selector switch that selects either the left/right differential signal or the up/down differential signal and outputs the selected signal and a band pass filter which allows a single frequency (e.g., the frequency f1) to be passed should be provided.

While the LED light source 12a and the LED light source 12b are disposed symmetrically relative to the center Po of the reflecting prism P, they may be disposed asymmetrically as long as the two LED light sources are positioned on the vertical center line CV. In other words, the distances from the two LED light sources to the center Po of the reflecting prism P do not need to match.

Another light source may be provided on the vertical center line CV in addition to the LED light source 12a and the LED light source 12b. As a greater number of light sources are used, the overall quantity of light received at the half-split light-receiving sensor 33A also increases to enable automatic aiming over a greater distance.

While the LED light source 12c and the LED light source 12d are disposed symmetrically relative to the center Po of the reflecting prism P, they may be disposed asymmetrically as long as the two LED light sources are positioned on the horizontal line CH. In other words, the distances from the two LED light sources to the center Po of the reflecting prism P do not need to match.

Another light source may be provided on the horizontal line CH in addition to the LED light source 12c and the LED light source 12d. As a greater number of light sources are used, the overall quantity of light received at the half-split light-receiving sensor 33B also increases to enable automatic aiming over a greater distance.

If the distance between the surveying instrument Ts and the target T is small, either of the automatic aiming LED light sources 12a and 12b may be omitted and either of the LED light sources 12c and 12b may be omitted. While the quantities of light received at the half-split light-receiving sensor 33A and the half-split light-receiving sensor 33B become smaller when the number of LED light sources is halved and, as a result, the automatic aiming is only enabled over a distance shortened to 1/√2, the production cost on the target T is lowered by reducing the number of LED light sources.

Instead of using the bandpass filter 62, a digital filter processing may be executed by utilizing a digital signal processor (DSP) or the like.

### Second Embodiment

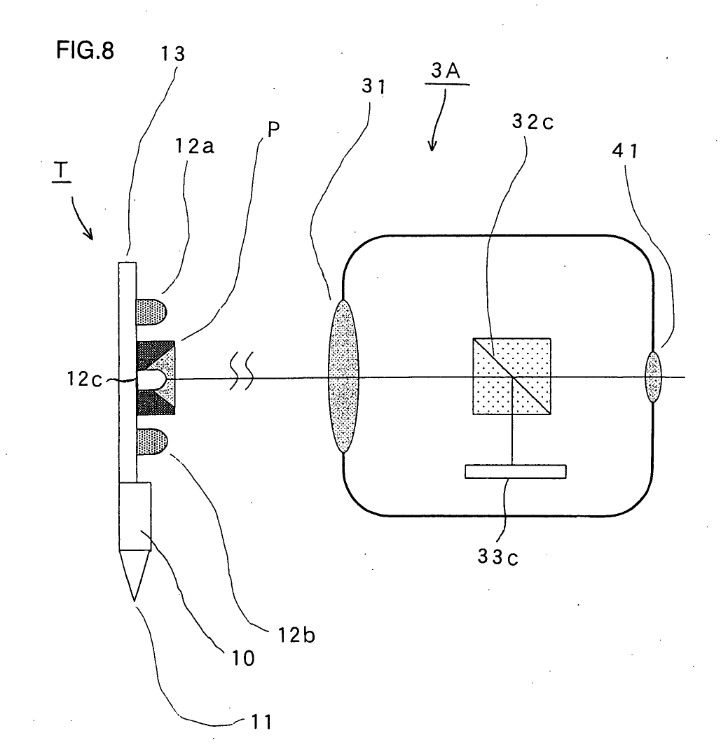

Alternatively, the dichroic prism 32 and the light-receiving element 33 in FIG. 3 may each be constituted as a single element. FIG. 8 shows structural features of a telescope unit 3A used in automatic aiming in the second embodiment. As in the first embodiment, the target T in FIG. 8 includes a pair of LED light sources 12a and 12b disposed along the up/down (vertical) direction and a pair of LED light sources 12c and 12d disposed along the left/right (horizontal) direction.

As in the first embodiment, the modulation frequencies at the LED light sources 12a to 12d are set so that the LED light source 12a and the LED light source 12b emit modulated light with the frequency f1 and that the LED light source 12c and the LED light source 12d emit modulated light with the frequency f2. The second embodiment differs from the first embodiment in that the emission wavelengths at the LED light sources 12a through 12d are all set equal to one another (e.g., to λ1).

A dichroic prism 32C corresponds to the dichroic prism 32 in FIG. 3 and a quarter-split light-receiving sensor 33C corresponds to the light-receiving element 33 in FIG. 3. The quarter-split light-receiving sensor 33C is a light-receiving sensor constituted of four photodiodes (PDs) disposed so that two photodiodes are set side-by-side both along the left/right (horizontal) direction and along the up/down (vertical) direction and the individual photodiodes constituting the light-receiving sensor each output a light reception signal.

The modulated light projected from the LED light sources 12a to 12d enters the dichroic prism 32C via the objective lens 31. The dichroic prism 32C redirects the wavelength component with the wavelength λ1 in the incident light and guides the redirected light to the quarter-split light-receiving sensor 33C and also allows a wavelength component that includes visible light to be passed through to be guided to the eyepiece lens 41. Thus, the light originating from the LED light source 12a and the light originating from the LED light source 12b disposed at an upper position and a lower position relative to the reflecting prism P and the light originating from the LED light source 12c and the light originating from the LED light source 12d disposed to the left and the right relative to the reflecting prism P are all received at the quarter-split light-receiving sensor 33C at the same time.

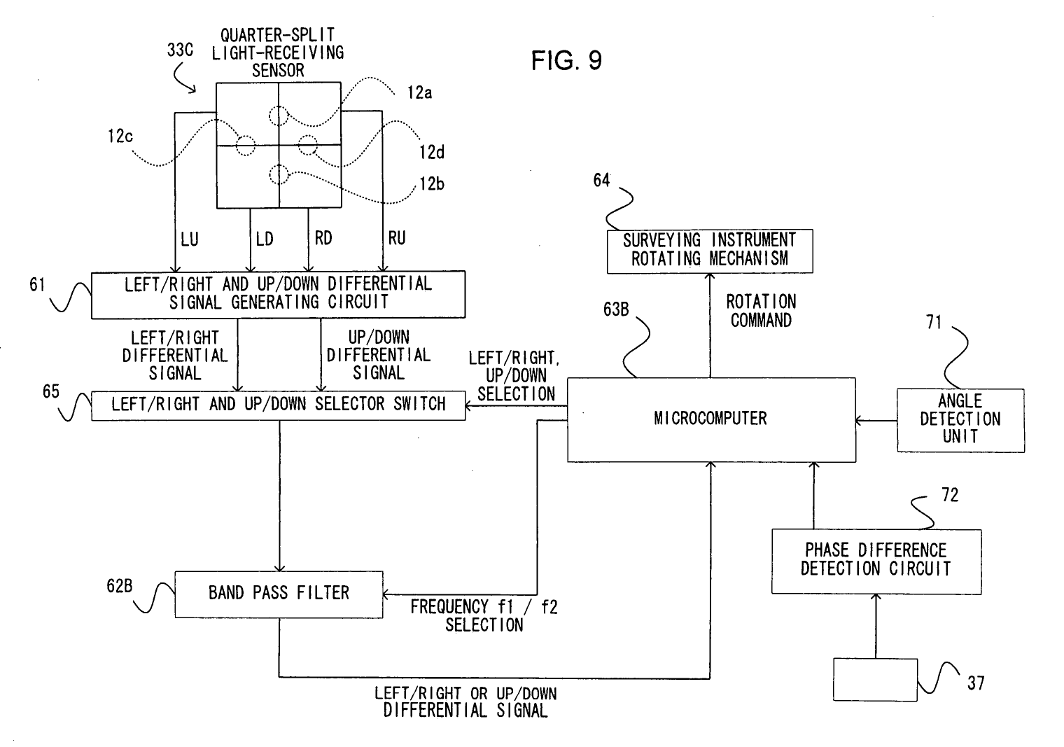

FIG. 9 is a block diagram of the surveying instrument Ts achieved in the second embodiment. The surveying instrument Ts in FIG. 9 includes a left/right and up/down differential signal generating circuit 61, a band pass filter 62B, a microcomputer 63B, a surveying instrument rotating mechanism 64 and a left/right and up/down selector switch 65. The same reference numerals are assigned to components identical to those in the first embodiment shown in FIG. 6 to preclude the necessity for a repeated explanation thereof.

Modulated light inverted along the left/right direction and the up/down direction depending upon the specific structure of the optical system enters the light-receiving surface of the quarter-split light-receiving sensor 33C. In order to facilitate the explanation, it is assumed in FIG. 9 that the upper left sensor outputs an LU signal, the lower left sensor outputs an LD signal, the upper right sensor outputs an RU signal and the lower right sensor outputs an RD signal. The light reception signals provided by the quarter-split light-receiving sensor 33C, i.e., the LU signal, the LD signal, the RU signal and the RD signal, are individually input to the left/right and up/down differential signal generating circuit 61. The left/right and up/down differential signal generating circuit 61 obtains a left/right differential signal by calculating the difference (LU signal+LD signal)−(RU signal+RD signal) and also obtains an up/down differential signal by calculating the difference (LU signal+RU signal)−(LD signal+RD signal).

In the second embodiment, when the optical axis of the telescope unit 3A is aligned along the direction of the center of the target T within the horizontal plane, the values of the sum (LU signal+LD signal) and the sum (RU signal+RD signal) are equal to each other and the left/right differential signal indicates a value of 0. When the optical axis of the telescope unit 3A is set further leftward (further toward the LED light source 12c) relative to the center of the target T within the horizontal plane, the sum (LU signal+LD signal) is larger than the sum (RU signal+RD signal) and thus, the value of the left/right differential signal ((LU+LD)−(RU+RD)) is larger than 0. When the optical axis of the telescope unit 3A is set further rightward (further toward the LED light source 12d) relative to the center of the target T within the horizontal plane, the sum (LU signal+LD signal) is smaller than the sum (RU signal+RD signal) and thus, the value of the left/right differential signal ((LU+LD)−(RU+RD)) is smaller than 0.

In addition, when the optical axis of the telescope unit 3A is aligned along the direction of the center of the target T within the vertical plane, the values of the sum (LU signal+RU signal) and the sum (LD signal+RD signal) are equal to each other and the up/down differential signal indicates a value of 0. When the optical axis of the telescope unit 3A is set further upward (further toward the LED light source 12a) relative to the center of the target T within the vertical plane, the sum (LU signal+RU signal) is larger than the sum (LD signal+RD signal) and thus, the value of the up/down differential signal ((LU+RU)−(LD+RD)) is larger than 0. When the optical axis of the telescope unit 3A is set further downward (further toward the LED light source 12b) relative to the center of the target T within the vertical plane, the sum (LU signal+RU signal) is smaller than the sum (LD signal+RD signal) and thus, the value of the up/down differential signal ((LU+RU)−(LD+RD)) is smaller than 0.

In response to a signal switch command issued by the microcomputer 63B, the left/right and up/down selector switch 65 selects either the left/right differential signal or the up/down differential signal and outputs the selected signal to the band pass filter 62B. In response to a frequency switch command output by the microcomputer 63B, the band pass filter 62B allows the signal with the frequency f1 or the signal with the frequency f2 to pass through to be output to the microcomputer 63B. When outputting a command to switch to the left/right differential signal to the left/right and up/down selector switch 65, the microcomputer 63B also outputs a command to switch to the frequency f1 to the band pass filter 62B, whereas when the microcomputer 63B outputs a command to switch to the up/down differential signal to the left/right and up/down selector switch 65, it also outputs a command to switch to the frequency f2 to the band pass filter 62B.

Based upon the left/right differential signal input in response to the commands issued to select the frequency f1 and the left/right differential signal, the microcomputer 63B outputs a horizontal rotation command to the surveying instrument rotating mechanism 64 to set the value of the differential signal to 0. In addition, based upon the up/down differential signal input in response to the commands issued to select the frequency f2 and the up/down differential signal, the microcomputer 63B outputs a vertical rotation command to the surveying instrument rotating mechanism 64 to set the value of the differential signal to 0.

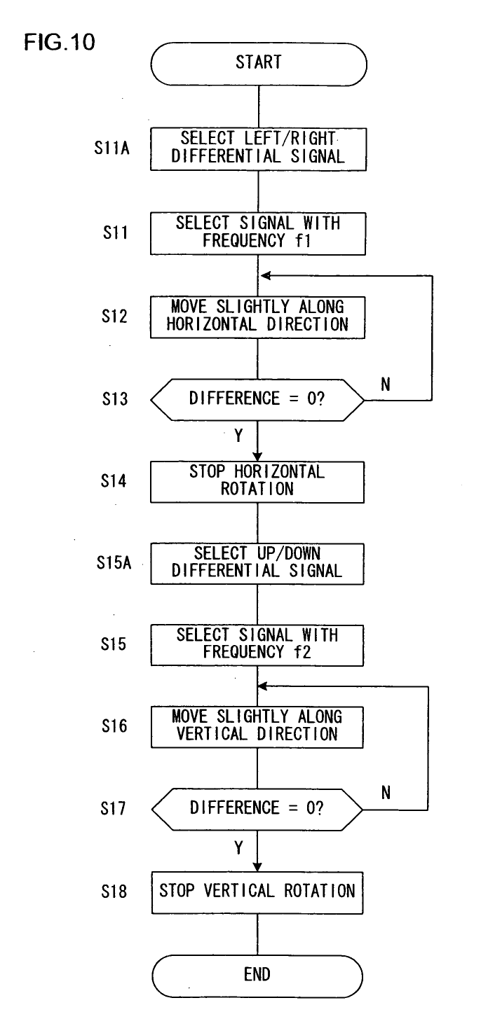

FIG. 10 presents a flowchart of the automatic aiming processing executed at the microcomputer 63B of the surveying instrument Ts described above. The processing differs from the processing shown in FIG. 7 in that additional steps S11A and S15A are executed. In step S11A, the microcomputer 63B outputs a command for the left/right and up/down selector switch 65 to select the left/right differential signal and then the operation proceeds to step S11. Since the subsequent processing is identical to that shown in FIG. 7, an explanation for it is omitted.

In step S15A, the microcomputer 63B outputs a command for the left/right and up/down selector switch 65 to select the up/down differential signal and then the operation proceeds to step S15. Since the subsequent processing is identical to that shown in FIG. 7, an explanation for it is omitted.

In addition to the advantages of the first embodiment, i.e., a measuring operation in both face-positions of the telescope is enabled and the accuracy of the angle measurement is improved both along the horizontal direction and along the vertical direction, the second embodiment described above achieves the following advantage. Namely, the light emitted by the LED light sources 12a to 12d all have the wavelength Al and the modulated light from the LED light sources 12a to 12d is received at the quarter-split light-receiving sensor 33C. As a result, the optical system required to enable automatic aiming is achieved as a light-receiving system constituted of a set of the dichroic prism 32C and the quarter-split light-receiving sensor 33C to realize a cost reduction and further miniaturization of the surveying instrument compared to the first embodiment.

While the half-split light-receiving sensor and the quarter-split light-receiving sensor are each constituted of photodiodes in the explanation provided above, they may instead be constituted by using CCD image sensors.

The present invention may also be adopted in a surveying instrument that does not have a distance measuring function and is equipped only with an angle measuring function, such as a the odolite.

The structural elements of the target of the surveying instrument in the embodiments may be alternatively referred to as follows. The term “reference point” may be used to refer to, for instance, the center Po of the reflecting prism P. A term “vertical line” may be used, for instance, to refer to the vertical center line CV. A first light emitting body may be constituted of the LED light sources 12a and 12b. A second light emitting body may be constituted with, for instance, the LED light sources 12c and 12d. A first light wavelength discriminating device may be constituted of, for instance, the dichroic prism 32A. A first light-receiving device may be constituted with, for instance, the half-split light-receiving sensor 33A. A second light wavelength discriminating device may be constituted of, for instance, the dichroic prism 32B. A second light-receiving device may be constituted with, for instance, the half-split light-receiving sensor 33B. An aiming control device may be constituted with, for instance, the microcomputer 63 (63B). A first adjustment signal may correspond to, for instance, the horizontal rotation command. A second adjustment signal may correspond to, for instance, a vertical rotation command. A first frequency discriminating device and a second frequency discriminating device may be constituted with, for instance, the band pass filter 62 (62B).

A light wavelength discriminating device may be constituted with, for instance, the dichroic prism 32C. A light-receiving device may be constituted with, for instance, the quarter-split light-receiving sensor 33C. A photoelectric conversion signal provided by the two light-receiving elements located on the left side along the horizontal direction may correspond to, for instance, the sum (LU signal+LD signal). A photoelectric conversion signal provided by the two light-receiving elements located on the right side along the horizontal direction may correspond to, for instance, the sum (RU signal+RD signal) A first signal processing device and a second signal processing device may be constituted with, for instance, the left/right and up/down differential signal generating circuit 61. A photoelectric conversion signal provided by the two light-receiving elements located on the upper side along the vertical direction may correspond to, for instance, the sum (LU signal+RU signal). A photoelectric conversion signal provided by the two light-receiving elements located on the lower side along the vertical direction may correspond to, for instance, the sum (LD signal+RD signal).

The following advantages are achieved through the target for surveying and the surveying instrument described by using the expressions listed above. Since the first light emitting body is disposed on a vertical line passing through the specific reference point and the second light emitting body is disposed on a horizontal line extending perpendicular to the vertical line, the target for surveying can be achieved through a simple structure. Since the light emitting characteristics of the first light emitting body and the light emitting characteristics of the second light emitting body differ from each other, the light-receiving bodies can be distinguished from each other on the light-receiving side that includes the surveying instrument and the like.

In addition, signal light from the first light emitting body at the target is received through the surveying objective lens and aiming along the horizontal direction is achieved based upon the received signal, and also, signal light from the second light emitting body at the target is received through the surveying objective lens and aiming along the vertical direction is achieved based upon the received signal. As a result, since the light from the first light emitting body and the light from the second light emitting body to be used for the aiming enter the surveying instrument via the surveying objective lens, a measuring operation in both face-positions of the telescope, which is difficult to execute in the related art, even with a surveying instrument having an automatic aiming function can be executed. Furthermore, compared to a surveying instrument having objective lenses individually provided in conjunction with the surveying optical system and the aiming optical system, a more compact surveying instrument is achieved.

The above described embodiments are examples, and various modifications can be made without departing from the spirit and scope of the invention.

What is claimed is;

1. A target for surveying, comprising:
a reference point and at least one first light emitting body disposed on a vertical line passing through the reference point; and
at least one second light emitting body disposed on a horizontal line passing through the reference point and achieving light emitting characteristics different from the light emitting characteristics of the first light emitting body.

2. A target for surveying according to claim 1, wherein:
the light emitting characteristics of the first light emitting body and the light emitting characteristics of the second light emitting body differ from each other at least either in an emission wavelength or in a modulation frequency.

3. A target for surveying according to claim 1, wherein:
the first light emitting body is provided as a pair of light emitting bodies disposed above and below the reference point on the vertical line; and
the second light emitting body is provided as a pair of light emitting bodies disposed left and right relative to the reference point on the horizontal line.

4. A surveying instrument comprising:
a first reception device that receives signal light originating from the first light emitting body provided at a target for surveying according to claim 1 through a surveying objective lens;
a second reception device that receives signal light originating from the second light emitting body provided at the target for surveying through the surveying objective lens; and
an aiming control device that generates a first adjustment signal to be used to achieve aiming along a horizontal direction with the surveying objective lens based upon the signal received at the first reception device and generates a second adjustment signal to be used to achieve aiming along a vertical direction with the surveying objective lens based upon the signal received at the second reception device.

5. A surveying instrument according to claim 4, wherein:
the first reception device comprises at least a first light wavelength discriminating device that discriminates for light corresponding to a wavelength component of the light emitted by the first light emitting body and a first light-receiving device that comprises two light-receiving elements disposed side-by-side along the horizontal direction and receives the light selected by the first light wavelength discriminating device at the two light-receiving elements to execute photoelectric conversion; and
the second reception device comprises at least a second light wavelength discriminating device that discriminates for the light corresponding to a wavelength component of the light emitted by the second light emitting body and a second light-receiving device that comprises two light-receiving elements disposed side-by-side along the vertical direction and receives the light selected by the second light wavelength discriminating device at the two light-receiving elements to execute photoelectric conversion.

6. A surveying instrument according to claim 5, wherein:
the aiming control device generates the first adjustment signal so as to set a difference between photoelectric conversion signals from the two light-receiving elements of the first light-receiving device to substantially 0 and generates the second adjustment signal so as to set a difference between photoelectric conversion signals from the two light-receiving elements of the second light-receiving device to substantially 0.

7. A surveying instrument according to claim 5, wherein:
the first reception device further comprises a first frequency discriminating device that discriminates for a modulation frequency component of the signal light from the first light emitting body in photoelectric conversion signals obtained at the first light-receiving device; and
the second reception device further comprises a second frequency discriminating device that discriminates for a modulation frequency component of the signal light from the second light emitting body in photoelectric conversion signals obtained at the second light-receiving device.

8. A surveying instrument, comprising:
a light wavelength discriminating device that discriminates for both light originating from the first light emitting body and light originating from the second light emitting body provided at a target for surveying according to claim 1, which enter therein through a surveying objective lens;
a light-receiving device having four light-receiving elements disposed side-by-side along a horizontal direction and along a vertical direction, which receives light discriminated for at the light wavelength discriminating device at the four light-receiving elements and performs photoelectric conversion of the received light;
a first signal processing device that individually extracts photoelectric conversion signals provided by the two light-receiving elements located on the left side along the horizontal direction at the light-receiving device and photoelectric conversion signals provided by the two light-receiving elements located on the right side along the horizontal direction at the light-receiving device;
a first frequency discriminating device that discriminates for a modulation frequency component of the signal light from the first light emitting body in the photoelectric conversion signals extracted by the first signal processing device;
a second signal processing device that individually extracts the photoelectric conversion signals provided by the two light-receiving elements located on the upper side along the vertical direction at the light-receiving device and the photoelectric conversion signals provided by the two light-receiving elements located on the lower side along the vertical direction at the light-receiving device;
a second frequency discriminating device that discriminates for a modulation frequency component of the signal light from the second light emitting body in the photoelectric conversion signals extracted by the second signal processing device; and
an aiming control device that generates a first adjustment signal to be used to achieve aiming along the horizontal direction with the surveying objective lens based upon a discriminate signal provided by the first frequency discriminating device and generate a second adjustment signal to be used to achieve aiming along the vertical direction with the surveying objective lens based upon a discriminate signal provided by the second frequency discriminating device.

9. A surveying instrument according to claim 8, wherein:
the aiming control device generates the first adjustment signal so as to set a difference between the two photoelectric conversion signals having undergone a discriminating process executed by the first frequency discriminating device to substantially 0 and generates the second adjustment signal so as to set a difference between the two photoelectric conversion signals having undergone a discriminating process executed by the second frequency discriminating device to substantially 0.

10. A surveying instrument according to claim 4, wherein:
a surveying optical system and an aiming optical system share a single optical axis and the surveying optical system and the aiming optical system both include and share the surveying objective lens.

11. A surveying instrument according to claim 8, wherein:
a surveying optical system and an aiming optical system share a single optical axis and the surveying optical system and the aiming optical system both include and share the surveying objective lens.

12. A surveying instrument comprising:
a surveying device that measures at least either a distance to or an angle of a target for surveying through a surveying objective lens;
a reception device that receives signal light originating from a light emitting body provided at the target for surveying through the surveying objective lens and outputs a reception signal; and
an aiming control device that aims an optical axis of the surveying objective lens at the target for surveying based upon the reception signal obtained at the reception device.

13. A surveying instrument according to claim 12, wherein:
the reception device outputs a horizontal differential signal indicating an extent to which the optical axis of the surveying objective lens is offset relative to the target for surveying along a horizontal direction and a vertical differential signal indicating an extent to which the optical axis of the surveying objective lens is offset relative to the target for surveying along a vertical direction; and
the aiming control device aims the optical axis of the surveying objective lens at the target for surveying both along the horizontal direction and along the vertical direction based upon the horizontal differential signal and the vertical differential signal.

14. A surveying instrument according to claim 13, wherein:
the target for surveying comprises at least one first light emitting body positioned along the horizontal direction relative to the center of the target and at least one second light emitting body positioned along the vertical direction relative to the center of the target; and
the reception device outputs the vertical differential signal based upon signal light originating from the first light emitting body and outputs the horizontal differential signal based upon signal light originating from the second light emitting body.

15. A surveying instrument according to claim 12, wherein:
the surveying device executes measurement in both face-positions of a telescope.

16. An automatic aiming surveying system comprising:
a target for surveying according to claim 1; and
a surveying instrument, wherein:
the surveying instrument comprises;
a first reception device that receives signal light originating from the first light emitting body provided at the target for surveying through a surveying objective lens;
a second reception device that receives signal light originating from the second light emitting body provided at the target for surveying through the surveying objective lens; and
an aiming control device that generates a first adjustment signal to be used to achieve aiming along a horizontal direction with the surveying objective lens based upon a reception signal obtained at the first reception device and generates a second adjustment signal to be used to achieve aiming along a vertical direction with the surveying objective lens based upon a reception signal obtained at the second reception device.

17. An automatic aiming surveying system comprising:
a target for surveying; and
a surveying instrument, wherein:
the surveying instrument comprises;
a surveying device that measures at least either a distance to or an angle of the target for surveying through a surveying objective lens;
a reception device that receives signal light originating from a light emitting body provided at the target for surveying through the surveying objective lens and outputs a reception signal; and
an aiming control device that aims an optical axis of the surveying objective lens at the target for surveying based upon the reception signal obtained at the reception device.
